(19) United States
(12) Patent Application Publication
(10) Pub. No.: US 2025/0363518 A1
(43) Pub. Date: Nov. 27, 2025

(54) DYNAMIC MILESTONE TRACKING

(71) Applicant: American Express Travel Related Services Company, Inc., New York, NY (US)

(72) Inventor: Akshay Sharma, Gurgaon (IN)

(21) Appl. No.: 18/669,708

(22) Filed: May 21, 2024

(51) Int. Cl. G06Q 30/0226

(52) U.S. Cl. CPC G06Q 30/0226

(57) ABSTRACT

Disclosed are various embodiments for implementing a dynamic milestone tracking system for customer awards. To begin, a computing device can receive a milestone input associated with a user profile. Then, the computing device can determine an estimated value of a milestone corresponding to the milestone input. The computing device can further determine a progress percentage for the milestone based at least in part on the estimated value of the milestone and a balance associated with the user profile. Finally, the computing device can send the progress percentage to a client device for presentation in a user interface.

### BACKGROUND

Many organizations may wish to reward customers who engage in certain actions. In some situations, these organizations can use award structures to grant customers benefits in points, cash back, discounts, or other award structures. However, organizations may face difficulties in converting these awards into tangible goals for customers to achieve. For example, due to fluctuations in prices, redemption rates, or exchange rates, accrued awards may fluctuate in value. Accordingly, the tangible goals that a customer could achieve can vary over time for a given value of accrued awards.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface diagram illustrating an example of a user experience according to various embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a flowchart illustrating one example of functionality implemented as portions of an application executed in a computing environment in the network environment of FIG. 2 according to various embodiments of the present disclosure.

### DETAILED DESCRIPTION

Disclosed are various approaches for implementing a dynamic milestone tracking system for customer awards. Often, organizations award points, currency, discounts, giveaways, or other awards to customers who engage in desired activities. While many customers may accumulate awards, few tend to fully utilize them. Oftentimes, this underutilization can be attributed to a lack of clarity regarding the value of these awards, leaving customers unsure how to engage with or redeem what they have earned. The ability to provide a customer with a tangible goal or milestone, as well as a dynamic visual representation of their progress toward achieving that milestone, can increase customer engagement, and allow customers to reap all the benefits of their continued activities with the organization.

However, conversion of awards to tangible milestones can prove difficult for an organization depending on a number of factors. For example, if an organization uses a point system to reward various types of spending with a credit account, the conversion of points back to dollars can be complex and variable. Furthermore, conversion of those same points into experiences can involve multiple layers of conversions (e.g., points to dollars, dollars to estimated costs of experiences, etc.). To make matters more challenging, each layer of conversion can change with time as economic factors change daily.

Accordingly, various embodiments of the present disclosure provide for a dynamic milestone tracking system for customer awards. A user can choose a milestone to work toward and provide a number of parameters which the system can use to determine an estimated monetary value of the milestone. The system can then use various calculations to convert the estimated monetary value of the milestone into an estimated awards value. Using current information about a user, the system can evaluate a current award balance and produce a progress tracking element which can then be generated in a user interface to visually demonstrate to a user how close they are to achieving their milestone. At any point, a user can update a milestone parameter, and the estimates will be adjusted as well as the progress tracking. Additionally, whenever the awards balance changes due to user activity, the estimates and progress can be recalculated.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

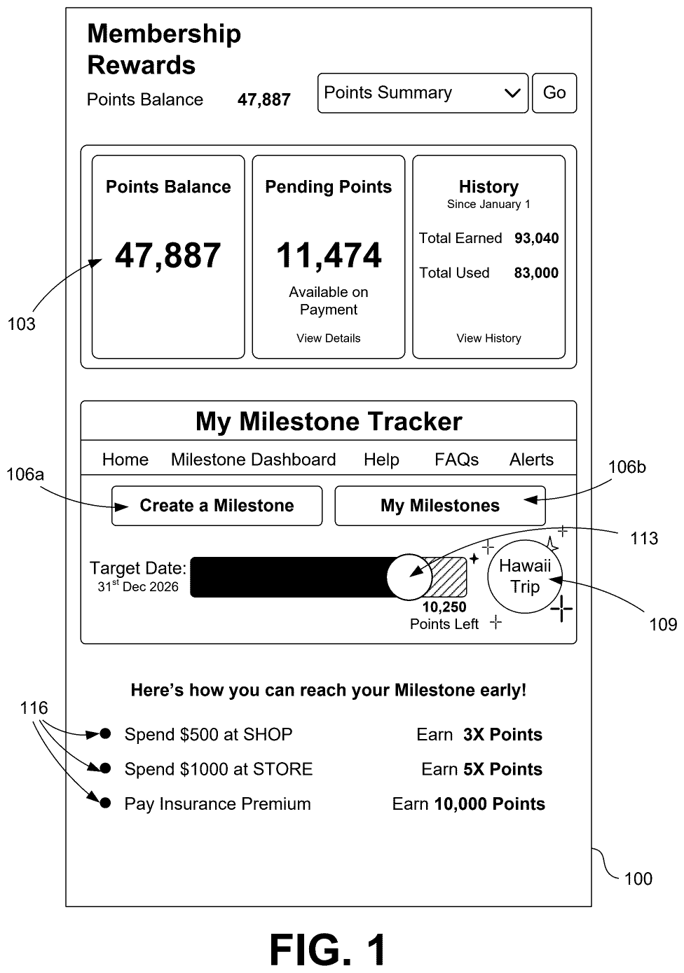

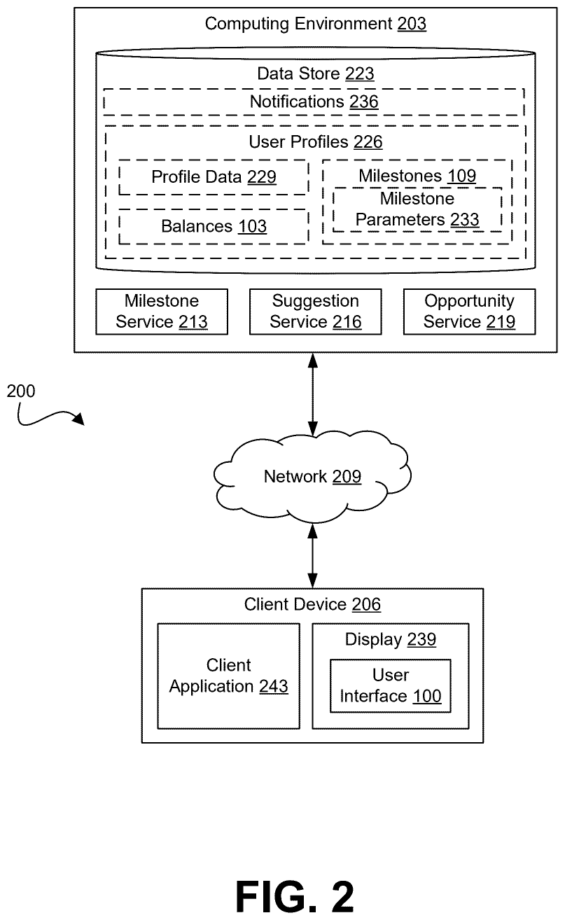

FIG. 1 depicts an example of a user interface 100 for presenting a user with a visual representation of their awards. The user interface 100 can show various information associated with a user awards account, including a visual representation of their total balance 103 and the potential value of that balance 103. The user interface 100 can include one or more user interface elements 106 (e.g., 106a, 106b, etc.) with which a user can interact to view, set up, modify, or otherwise manage a milestone 109. Milestones 109 can be representative of any type of goals which can be earned with awards, as described further in the discussion of FIG. 2.

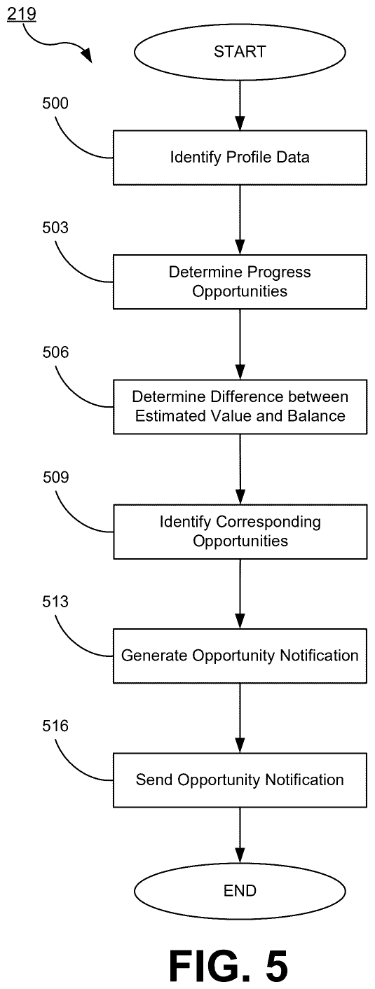

In addition to presenting a user's milestones 109, the user interface 100 can include a visual representation of the user's progress percentage 113 or progress toward their milestone 109. As shown in the example of FIG. 1, the progress percentage 113 can be shown as an icon in a progress bar. However, the progress percentage 113 can be shown in a variety of other ways, such as, for example, a portion of a pie chart, a progression around a circle, the filling of a container, or some other way to demonstrate visual progress. In some embodiments, the user interface 100 can include visual and written progress percentages 113 by displaying a visual icon as well as a written message informing the user of their progress. In some cases, the user interface 100 can present progress opportunities 116 to demonstrate different ways that a user can expedite achieving their milestone 109. Progress opportunities 116 are described further in the discussion of FIGS. 2 and 5.

According to various examples, interactions with the various elements appearing in the user interface 100 can result in the addition, subtraction, or modification of milestones 109 and respective progress percentages 113. For example, a user can interact with user interface element 106a to make a new milestone 109, which can lead to the generation of a new progress percentage 113. The additional milestone 109 and respective progress percentage 113 can appear on the user interface 100. In another example, if a user's balance 103 increases or decreases, the system can update the progress percentages 113 for each of the milestones 109 associated with the user. The respective progress percentages 113 in the user interface 100, along with a variety of other elements such as the progress opportunities 116, can be adjusted to reflect the updates.

With reference to FIG. 2, shown is a network environment 200 according to various embodiments. The network environment 200 can include a computing environment 203 and a client device 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a milestone service 213, a suggestion service 216, an opportunity service 219, and other applications, services, processes, systems, engines, or functionality not discussed in detail herein.

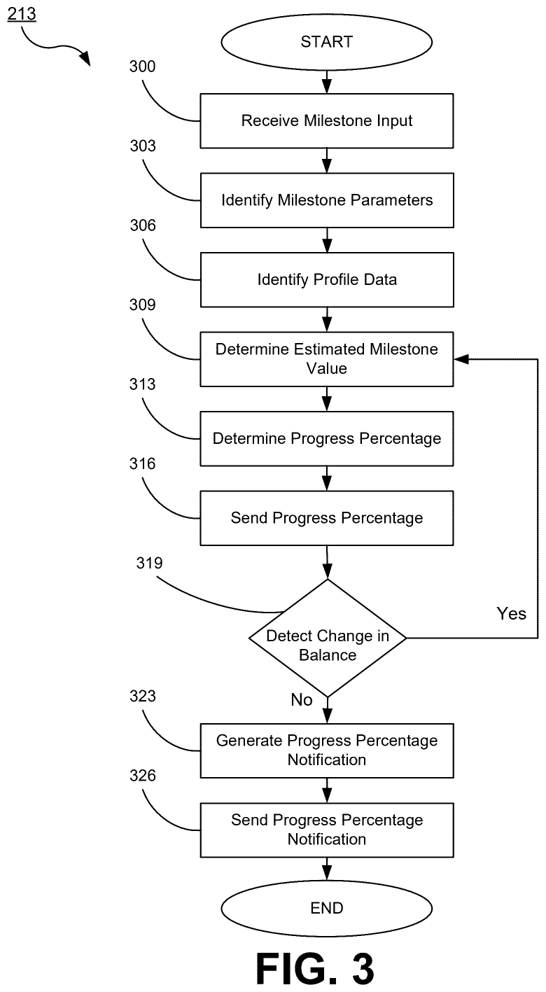

The milestone service 213 can be executed to initiate a milestone 109 according to a user input. In some embodiments, the milestone service 213 can receive a milestone input, determine an estimated value of a milestone 109 corresponding to the milestone input, determine a progress percentage 113 for the milestone 109 based at least in part on the estimated value and a balance 103 associated with the user, and send the progress percentage 113 to a client device 206 for presentation in a user interface 100. In some embodiments, the milestone service 213 can also detect changes in a balance 103 and modify the estimated value of the milestone 109 as well as the respective progress percentage 113. Other functionalities can also be provided in various implementations. Further description of the operation and capabilities of the milestone service 213 is described in the discussion of FIG. 3.

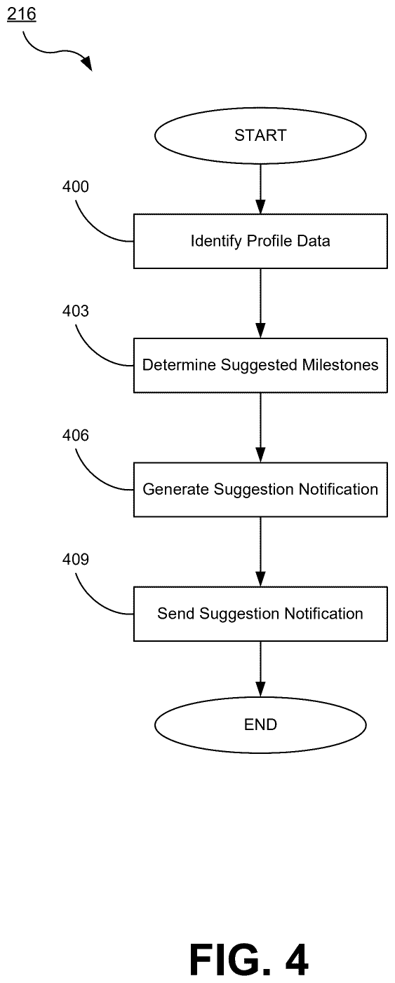

The suggestion service 216 can be executed to identify and use various data associated with a user to determine one or more suggested milestones 109. The suggestion service 216 can generate a suggestion notification for individual suggested milestones 109 and send the suggestion notification to a client device 206. Other functionalities can also be provided in various implementations. Further description of the operation and capabilities of the suggestion service 216 is described in the discussion of FIG. 4.

The opportunity service 219 can be executed to identify and use various data associated with a user to determine one or more progress opportunities 116. A progress opportunity 116 can be representative of an opportunity for a user to make significant or special progress toward achieving their milestone(s) 109. For example, a progress opportunity 116 can be a special offer, promotion, a limited-time deal, or other form of opportunity where a user can engage in a particular activity to earn more awards toward their milestone 109. The opportunity service 219 can identify a difference between the estimated value of a milestone 109 and the balance 103 associated with the user and identify progress opportunities 116 corresponding to that difference. In some examples, the opportunity service 219 can generate opportunity notifications which the opportunity service 219 can then send to a client device 206. Other functionalities can also be provided in various implementations. Further description of the operation and capabilities of the opportunity service 219 is described in the discussion of FIG. 5.

Also, various data is stored in a data store 223 that is accessible to the computing environment 203. The data store 223 can be representative of a plurality of data stores 223, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 223 is associated with the operation of the various applications or functional entities described below. This data can include user profiles 226 having profile data 229 and balances 103, milestones 109 and milestone parameters 233, notifications 236, and potentially other data.

The user profiles 226 can represent an account, page, or other form of profile which is associated with a user and contains a variety of information about the user. In some cases, the user profiles 226 can represent a transaction account (e.g., credit or charge card account, demand deposit account, stored value payment account, etc.), rewards account, user account, or other collection of user account information. The user profiles 226 can include profile data 229 such as a user identifier, a plurality of records associated with the user profile 226, one or more milestones 109, user settings and permissions, user type, profile type, engagement history, and potentially other profile data 229. A user identifier can represent any identifier which is unique to the client. The plurality of records can represent any number of records initiated, received, or otherwise associated with the user profile 226. A user type can represent an identifier distinguishing the type of client, such as whether the client is a person or business, a premium client, etc. Similarly, a profile type can represent a distinguishing feature of the profile, such as whether the profile is a transaction account, rewards account, booking account, or other, as well as whether the profile is a standard profile, premium profile, etc. An engagement history can include different metrics of engagement with the user profile 226 such as the balance 103, the milestones 109, the number of records associated with the user profile 226 and the frequency with which records are made, as well as engagement with additional features offered with the user profile 226. A balance 103 can represent a value or quantity of a medium of exchange such as currency, rewards points, vouchers, coupons, or other form of award.

A milestone 109 can represent a goal or achievement. In some embodiments, a milestone 109 can be specific merchandise, a booking or reservation, cash back, a gift card, an experience, or some other form of goal which a user can earn toward. The milestone 109 can include one or more milestone parameters 233 which provide greater detail for the milestone service 213 to determine an estimated value. For example, a milestone 109 which represents a trip to Hawaii can incorporate a number of different milestone parameters 233 such as the departure location for a flight to Hawaii, the dates of travel as well as the preferred flight time of the user, the class of the plane ticket, the airline, as well as various other accommodations such as a hotel, rental car, etc. In another example, when the milestone 109 is a gift card or specific merchandise, the milestone parameters 233 can represent the price of the card or the merchandise, the vendor or merchant associated with the card or merchandise, sale information, as well as other factors which may impact the value of the milestone 109.

The notifications 236 can be representative of messages sent and received by the various services in the network environment 200. Notifications 236 can include prompts for information, alerts, messages, requests, and confirmations exchanged between the various services. In some embodiments, the notifications 236 are generated by one service based at least in part on data received from another service. In some embodiments, the notifications 236 can be representative of templates which can be sent as forms or modified based at least in part on incoming data. Notifications 236 can include progress percentage notifications generated and sent by the milestone service 213, suggestion notifications generated and sent by the suggestions service 216, opportunity notifications generated and sent by the opportunity service 219.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 239, such as liquid crystal displays (LCDs), gas plasma-based flat panel displays, organic light emitting diode (OLED) displays, electrophoretic ink (“E-ink”) displays, projectors, or other types of display devices. In some instances, the display 239 can be a component of the client device 206 or can be connected to the client device 206 through a wired or wireless connection.

The client device 206 can be configured to execute various applications such as a client application 243 or other applications. The client application 243 can be executed in a client device 206 to access network content served up by the computing environment 203 or other servers, thereby rendering a user interface 100 on the display 239. To this end, the client application 243 can include a browser, a dedicated application, or other executable, and the user interface 100 can include a network page, an application screen, or other user mechanism for obtaining user input. The client device 206 can be configured to execute applications beyond the client application 243 such as email applications, social networking applications, word processors, spreadsheets, or other applications.

Next, a general description of the operation of the various components of the network environment 200 is provided. To begin, a user can provide a milestone input (e.g., a milestone 109 and/or one or more milestone parameters 233) associated with their user profile 226. The milestone service 213 can determine an estimated value of a milestone 109 which corresponds to the milestone input. Next, the milestone service 213 can determine a progress percentage 113 for the milestone 109 based at least in part on the estimated value of the milestone 109 and a balance 103 associated with the user profile 226. The milestone service 213 can send the progress percentage 113 to a client device 206 for presentation in a user interface 100.

In some embodiments, the milestone service 213 can detect a change in the balance 103 and modify the estimated value of the milestone 109 and the progress percentage 113 respectively. The milestone service 213 can then send the modified progress percentage 113 to the client device 206 for presentation in the user interface 100. In some embodiments, the milestone service 213 can generate a notification 236 based at least in part on the modified progress percentage 113 and send the notification 236 to the client device 206. The milestone service 213 can detect a change in the balance 103 and determine that the progress percentage 113 for a milestone 109 is complete. The milestone service 213 can generate a milestone complete notification 236 and send the milestone complete notification 236 to the client device 206.

The suggestion service 216 can identify profile data 229 associated with the user profile 226 and determine one or more suggested milestones 109 for the user profile 226 based at least in part on the balance 103 and the profile data 229. In some embodiments, the suggestion service 216 can generate a notification 236 comprising the one or more suggested milestones 109 and send the notification 236 to the client device 206.

Similarly, the opportunity service 219 can identify profile data associated with the user profile 226 and determine one or more progress opportunities 116 based at least in part on the profile data 229 and the progress percentage 113 for a particular milestone 109. The opportunity service 219 can determine a difference between the estimated value of the milestone 109 and the balance 103 and identify one or more progress opportunities 116 which correspond to the difference. In some embodiments, the opportunity service 219 can generate a notification 236 comprising the one or more progress opportunities 116 and send the notification 236 to the client device 206.

Referring next to FIG. 3, shown is a flowchart that provides one example of the operation of a portion of the milestone service 213. The flowchart of FIG. 3 provides merely an example of the many different types of functional arrangements that can be employed to implement the operation of the depicted portion of the milestone service 213. As an alternative, the flowchart of FIG. 3 can be viewed as depicting an example of elements of a method implemented within the network environment 200.

Beginning with block 300, the milestone service 213 can be executed to receive a milestone input. The milestone input can represent a selection of a milestone 109, the addition, deletion, or modification of a milestone parameter 233, a selection of a suggested milestone 109 (as described in FIG. 4), or another input related to a milestone 109 associated with a user profile 226. The milestone input can be input by a user through a user interface 100 on a client device 206 and sent from the client device 206 to the milestone service 213 over the network 209. In some embodiments, the milestone service 213 can receive the milestone input from the client application 243 on the client device 206. In some embodiments, the milestone service 213 can receive the milestone input from another system, service, or application in the network environment 200.

Next, at block 303, the milestone service 213 can be executed to identify one or more milestone parameters 233. The milestone parameters 233 can be associated with the milestone input received at block 300. In at least one embodiment, the milestone parameters 233 can be received as the milestone input. The milestone parameters 233 can also be received along with the milestone input or, in some cases, can be identified based at least in part on the user profile 226 associated with the milestone input. The milestone service 213 can identify the one or more milestone parameters 233 based at least in part on the milestone input received at block 300. In some embodiments, the milestone service 213 can identify the milestone parameters 233 by sending a request for user input of the milestone parameters 233. In some embodiments, the milestone service 213 can identify the one or more milestone parameters 233 from a data store 223 or another system, service, or application in the network environment 200.

At block 306, the milestone service 213 can be executed to identify profile data 229 associated with the user profile 226. The milestone service 213 can identify the profile data 229 based at least in part on the milestone input received at block 300. The milestone service 213 can identify profile data 229 based at least in part on the user profile 226 associated with the milestone input received at block 300. In some embodiments, the milestone service 213 can obtain the profile data 229 from a data store 223, or receive the profile data 229 from another system, service, or application in the network environment 200.

At block 309, the milestone service 213 can be executed to determine an estimated value of a milestone 109 corresponding to the milestone input. The milestone service 213 can access information from other systems, servers, or computing environments 203 within the network environment 200. In some embodiments, the milestone service 213 can obtain information from third parties over the network 209 to determine the estimated value of the milestone 109. The milestone service 213 can determine the estimated value of the milestone 109 based at least in part on one or more of the following: the milestone input received at block 300, the milestone parameters 233 associated with the milestone 109, the profile data 229 associated with the user profile 226, various economic factors, and/or data obtained from one or more third parties.

Next, at block 313, the milestone service 213 can determine a progress percentage 113 for the milestone 109. In some embodiments, the progress percentage 113 can be determined by the milestone service 213 based at least in part on the estimated value of the milestone 109 and a balance 103 associated with the user profile 226. For example, the milestone service 213 can determine the progress percentage 113 by comparing the balance 103 associated with the user profile 226 to the estimated value of the milestone 109 and evaluating how close the balance 103 is to the estimated value of the milestone 109. The closer the balance 103 is to the estimated value of the milestone 109, the closer the progress percentage 113 is to 100%. In some embodiments, the milestone service 213 can determine the progress percentage 113 based at least in part on the total number of milestones 109 associated with the user profile 226. For example, a setting can provide for the milestone service 213 to split the balance 103 among two or more milestones 109 according to various weights in order to determine the respective progress percentages 113.

At block 316, the milestone service 213 can be executed to send the progress percentage 113. The milestone service 213 can send the progress percentage 113 determined at block 313 to a client device 206 for presentation in a user interface 100. In some embodiments, the milestone service 213 can send the progress percentage 113 to a data store 223 or another system, service, or application in the network environment 200.

At block 319, the milestone service 213 can be executed to detect a change in the balance 103. If a change in the balance 103 is positively detected, the milestone service 213 can repeat the steps identified in blocks 309 to 316. For example, the milestone service 213 can modify the estimated value of the milestone 109 as described at block 309. Then, the milestone service 213 can modify the progress percentage 113 based at least in part on the modified estimated value of the milestone 109, as described at block 313, and further based at least in part on the change in balance 103 that was detected. Next, the milestone service 213 can send the modified progress percentage 113 to the client device 206 for presentation in the user interface 100, as described in block 316. If no change is detected in the balance 103, the milestone service 213 can proceed to block 323 or end.

At block 323, the milestone service 213 can be executed to generate a notification 236 based at least in part on the progress percentage 113 determined at block 313. The milestone service 213 can obtain a notification 236 from a data store 223 and modify the notification 236 to include the progress percentage 113 determined at block 313. In some embodiments, the progress percentage 113 is 100% and the milestone 109 is complete. In these embodiments, the milestone service 213 can generate a milestone complete notification 236. According to various examples, the milestone service 213 can generate the notification 236 based at least in part on the progress percentage 113, the milestone 109, the balance 103, profile data 229, and/or other factors.

Next, at block 326, the milestone service 213 can be executed to send the notification 236 generated at block 326. In some embodiments, the milestone service 213 can send the notification 236 to the client application 243 on the client device 206, so the client application 243 can cause the notification 236 to be displayed on the user interface 100. In some embodiments, the milestone service 213 can send the notification 236 to a display 239 for presentation in a user interface 100. The milestone service 213 can be executed to send the notification 236 to another system, service, or application in the network environment 200. After block 326, the flowchart of FIG. 3 ends.

Turning now to FIG. 4, shown is a flowchart that provides one example of the operation of a portion of the suggestion service 216. The flowchart of FIG. 4 provides merely an example of the many different types of functional arrangements that can be employed to implement the operation of the depicted portion of the suggestion service 216. As an alternative, the flowchart of FIG. 4 can be viewed as depicting an example of elements of a method implemented within the network environment 200.

Beginning with block 400, the suggestion service 216 can be executed to identify profile data 229 associated with the user profile 226. The suggestion service 216 can identify the profile data 229 based at least in part on an input received from the milestone service 213, the opportunity service 219, or another service or application in the network environment 200. In some embodiments, the suggestion service 216 can identify profile data 229 based at least in part on the user profile 226 associated with a received input. In some embodiments, the suggestion service 216 can obtain the profile data 229 from a data store 223, or receive the profile data 229 from another system, service, or application in the network environment 200.

Next, at block 403, the suggestion service 216 can be executed to determine one or more suggested milestones 109. The suggestion service 216 can determine one or more suggested milestones 109 for the user profile 226 based at least in part on the profile data 229 identified at block 400. In some embodiments, the suggestion service 216 can determine one or more suggested milestones 109 for the user profile 226 based at least in part on a balance 103 associated with the user profile 226. For example, the suggestion service 216 can evaluate the profile data 229 identified at block 400 to determine a user's purchase preferences, engagement history, and other relevant patterns of behavior which could impact the likelihood that the user would prefer a particular milestone 109. In some cases, the suggestion service 216 can determine the suggested milestones 109 based at least in part on special offers, promotions, limited-time deals, or other various factors associated with particular third parties or with the host of the suggestion service 216. The suggestion service 216 can determine one or more suggested milestones 109 with which a user is likely to engage.

Then, at block 406, the suggestion service 216 can be executed to generate a notification 236. In some embodiments, the suggestion service 216 can use a template notification 236 obtained from a data store 223 to generate a notification 236 comprising the one or more suggested milestones 109 which were determined at block 403. The suggestion service 216 can generate the notification 236 based at least in part on the profile data 229 identified at block 400, the suggested milestones 109 determined at block 403, or other various data obtained from the network environment 200.

At block 409, the suggestion service 216 can be executed to send the notification 236. The suggestion service 216 can send the notification 236 generated at block 406 to the client device 206 for presentation in a user interface 100. In some embodiments, the suggestion service 216 can send the notification 236 to the client application 243 on the client device 206, so the client application 243 can cause the notification 236 to be presented on the user interface 100. In some embodiments, the suggestion service 216 can send the notification 236 to a display 239 for presentation in a user interface 100. The suggestion service 216 can be executed to send the notification 236 to another system, service, or application in the network environment 200. After block 409, the flowchart of FIG. 4 ends.

Moving on to FIG. 5, shown is a flowchart that provides one example of the operation of a portion of the opportunity service 219. The flowchart of FIG. 5 provides merely an example of the many different types of functional arrangements that can be employed to implement the operation of the depicted portion of the opportunity service 219. As an alternative, the flowchart of FIG. 5 can be viewed as depicting an example of elements of a method implemented within the network environment 200.

Beginning with block 500, the opportunity service 219 can be executed to identify profile data 229. The opportunity service 219 can be executed to identify profile data 229 associated with the user profile 226. The opportunity service 219 can identify the profile data 229 based at least in part on an input received from the milestone service 213, the suggestion service 216, or another service or application in the network environment 200. In some embodiments, the opportunity service 219 can identify profile data 229 based at least in part on the user profile 226 associated with a received input. In some embodiments, the opportunity service 219 can obtain the profile data 229 from a data store 223, or receive the profile data 229 from another system, service, or application in the network environment 200.

At block 503, the opportunity service 219 can be executed to determine one or more progress opportunities 116. The opportunity service 219 can determine the one or more progress opportunities 116 based at least in part on the profile data 229 identified at block 500. In some embodiments, the opportunity service 219 can receive the progress percentage 113 determined by the milestone service 213 (see FIG. 3). The opportunity service 219 can then determine the progress opportunities 116 based at least in part on the progress percentage 113. For example, the opportunity service 219 can determine one or more progress opportunities 116 by evaluating a user's most frequented vendors, determining whether any special promotions are being offered at those vendors, and identifying those special promotions as progress opportunities 116.

At block 506, the opportunity service 219 can be executed to determine a difference between the estimated value of a milestone 109 and a balance 103. The opportunity service 219 can obtain the estimated value of the milestone 109 from the milestone service 213. The opportunity service 219 can identify the balance 103 from the profile data 229 identified in block 500. In some embodiments, the opportunity service 219 can compare the estimated value of the milestone 109 to the balance 103 and determine a difference from the comparison. In cases where there are multiple milestones 109 associated with a user profile 226, the opportunity service 219 can determine a respective difference between the balance 103 and each milestone 109.

Next, at block 509, the opportunity service 219 can be executed to identify one or more progress opportunities 116 which correspond to the difference determined at block 506. The opportunity service 219 can compare the determined differences from block 506 with the determined progress opportunities 116 from block 503 to identify progress opportunities 116 which correspond to the respective differences. For example, if the opportunity service 219 identified progress opportunities 116 where a user could earn 10,000 points by spending $1000 with a first merchant and 2× rewards on $500 spent at a second merchant (at a base rate of 2 points per dollar), and the opportunity service 219 identified a difference of 12,000 points, the opportunity service 219 could identify the 10,000 points offer as corresponding to the determined difference of 12,000 points instead of the 2,000 points opportunity. In some embodiments, the opportunity service 219 could identify the combination of the first offer and the second offer as corresponding to the difference.

At block 513, the opportunity service 219 can be executed to generate a notification 236 comprising the one or more progress opportunities 116 identified at block 509. In some embodiments, the opportunity service 219 can use a template notification 236 obtained from a data store 223 to generate a notification 236 comprising the one or more progress opportunities 116 which were determined at block 503 or identified at block 509. The opportunity service 219 can generate the notification 236 based at least in part on other various data obtained from the network environment 200.

At block 516, the opportunity service 219 can be executed to send the notification 236. The opportunity service 219 can send the notification 236 generated at block 513 to the client device 206 for presentation in a user interface 100. In some embodiments, the opportunity service 219 can send the notification 236 to the client application 243 on the client device 206, so the client application 243 can cause the notification 236 to be presented on the user interface 100. In some embodiments, the opportunity service 219 can send the notification 236 to a display 239 for presentation in a user interface 100. The opportunity service 219 can be executed to send the notification 236 to another system, service, or application in the network environment 200. After block 516, the flowchart of FIG. 5 ends.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
receive a milestone input associated with a user profile;
determine an estimated value of a milestone corresponding to the milestone input;
determine a progress percentage for the milestone based at least in part on the estimated value of the milestone and a balance associated with the user profile;
detect a change in the balance associated with the user;
in response to detection of the change in the balance associated with the user, modify the estimated value of the milestone to create a modified estimated value;
in response to detection of the change in the balance associated with the user, modify the progress percentage based at least in part on the modified estimated value of the milestone and the change in balance; and
in response to detection of the change in the balance associated with the user, send the modified progress percentage to the client device for presentation in the user interface.

2. (canceled)

3. The system of claim 1, wherein the machine-readable instructions further cause the computing device to at least:
generate a notification based at least in part on the modified progress percentage; and
send the notification to the client device.

4. The system of claim 1, wherein the machine-readable instructions which cause the computing device to determine an estimated value of a milestone, further cause the computing device to at least:
identify one or more milestone parameters associated with the milestone input;
identify profile data associated with the user profile; and
determine the estimated value of the milestone based at least in part on the milestone parameters and the profile data.

5. The system of claim 1, wherein the machine-readable instructions further cause the computing device to at least:
identify profile data associated with the user profile;
determine one or more suggested milestones for the user profile based at least in part on the balance and the profile data;
generate a notification comprising the one or more suggested milestones; and
send the notification to the client device.

6. The system of claim 1, wherein the machine-readable instructions further cause the computing device to at least:
identify profile data associated with the user profile;
determine one or more progress opportunities based at least in part on profile data and the progress percentage; and
generate a notification comprising the one or more progress opportunities; and
send the notification to the client device.

7. The system of claim 6, wherein the machine-readable instructions which cause the computing device to determine the one or more progress opportunities, further cause the computing device to at least:
determine a difference between the estimated value of the milestone and the balance; and
identify one or more progress opportunities which correspond to the difference.

8. A method, comprising:
receiving, by a computing device, a milestone input associated with a user profile;
determining, by the computing device, an estimated value of a milestone corresponding to the milestone input;
determining, by the computing device, a progress percentage for the milestone based at least in part on the estimated value of the milestone and a balance associated with the user profile;
detecting, by the computing device, a change in the balance;
modifying, by the computing device, the estimated value of the milestone;
modifying, by the computing device, the progress percentage based at least in part on the modified estimated value of the milestone and the change in balance; and
sending, by the computing device, the modified progress percentage to the client device for presentation within the user interface.

9. (canceled)

10. The method of claim 8, further comprising:
identifying, by the computing device, profile data associated with the user profile;
determining, by the computing device, one or more suggested milestones for the user profile based at least in part on the balance and the profile data; and
generating, by the computing device, a notification comprising the one or more suggested milestones.

11. The method of claim 10, further comprising:
receiving, by the computing device, a selection of a suggested milestone;
determining, by the computing device, an estimated value of the suggested milestone;
determining, by the computing device, a second progress percentage for the suggested milestone based at least in part on the estimated value of the suggested milestone and the balance; and
sending, by the computing device, the second progress percentage to the client device for presentation within the user interface.

12. The method of claim 8, further comprising:
determining, by the computing device, one or more progress opportunities based at least in part on profile data and the progress percentage;
generating, by the computing device, a notification comprising the one or more progress opportunities; and
sending, by the computing device, the notification to the client device.

13. The method of claim 8, further comprising:
detecting, by the computing device, a change in the balance;
determining, by the computing device, that the progress percentage for the milestone is complete;
generating, by the computing device, a milestone complete notification; and
sending, by the computing device, the milestone complete notification to the client device.

14. A system, comprising:
a computing device comprising a processor and a memory; and
machine-readable instructions stored in the memory that, when executed by the processor, cause the computing device to at least:
detect a change in a balance associated with a user profile;
in response to detection of the change, identify a milestone associated with the user profile;
in response to detection of the change, determine an estimated value of the milestone;
in response to detection of the change, determine a progress percentage for the milestone based at least in part on the estimated value and the change in the balance; and
send the progress percentage to a client device for presentation within a user interface.

15. The system of claim 14, wherein the machine-readable instructions further cause the computing device to at least:
receive a milestone parameter input;
modify the estimated value of the milestone based at least in part on the milestone parameter input;
modify the progress percentage based at least in part on the modified estimated value of the milestone; and
send the modified progress percentage to the client device for presentation within the user interface.

16. The system of claim 14, wherein the machine-readable instructions, when executed by the processor, further cause the computing device to at least:
determine that the progress percentage for the milestone is complete;
generate a milestone complete notification; and
send the milestone complete notification to the client device.

17. The system of claim 14, wherein the machine-readable instructions further cause the computing device to at least:
identify profile data associated with the user profile;
determine one or more suggested milestones for the user profile based at least in part on the balance and the profile data;
generate a notification comprising the one or more suggested milestones; and
send the notification to the client device.

18. The system of claim 17, wherein the machine-readable instructions further cause the computing device to at least:
receive a selection of a suggested milestone;
determine an estimated value of the suggested milestone;
determine a second progress percentage for the suggested milestone based at least in part on the estimated value of the suggested milestone and the balance; and
send the second progress percentage to the client device for presentation within the user interface.

19. The system of claim 14, wherein the machine-readable instructions further cause the computing device to at least:
determine a difference between the estimated value of the milestone and the balance;
identify one or more progress opportunities which correspond to the difference; and
generate a notification comprising the one or more progress opportunities.

20. The system of claim 19, wherein the machine-readable instructions further cause the computing device to at least:
determine a plurality of progress opportunities based at least in part on profile data and the progress percentage; and
identify one or more progress opportunities of the plurality of progress opportunities which correspond to the difference.
